(19) United States
(12) Patent Application Publication
(10) Pub. No.: US 2018/0005073 A1
(43) Pub. Date: Jan. 4, 2018

(54) ROAD RECOGNITION APPARATUS

(71) Applicant: DENSO CORPORATION, Kariya-city (JP)

(72) Inventors: Taiki KAWANO, Nishio-city (JP); Naoki KAWASAKI, Nishio-city (JP); Shunsuke SUZUKI, Kariya-city (JP); Akihiro WATANABE, Kariya-city (JP)

(21) Appl. No.: 15/639,985

(22) Filed: Jun. 30, 2017

(30) Foreign Application Priority Data
Jul. 4, 2016 (JP) 2016-132607

(51) Int. Cl. G06K 9/52; G06K 9/00; G06T 7/13; G06T 7/149

(52) U.S. Cl. CPC G06K 9/52; G06T 7/149; G06K 9/00798; G06T 7/13; G06T 2207/30256; B60Y 2400/3015

(57) ABSTRACT

In a road recognition apparatus mounted in a vehicle, a shape change point detector is configured to detect a shape change point along each of lane lines of an own lane. A turn-off lane determiner is configured to, if the shape change point is detected, determine whether or not a shape changing lane line that is one of the lane lines including the shape change point constitutes a border of a turn-off lane branching off from the own lane. A road recognizer is configured to, when the shape change point has been detected, use only feature points of the left and right lane lines of the own lane located within a distance from the own vehicle to the shape change point to recognize the shape of the own lane, before a result of determination by the turn-off lane determiner is produced.

### CROSS-REFERENCE TO RELATED APPLICATION

This application is based on and claims the benefit of priority from earlier Japanese Patent Application No. 2016-132607 filed Jul. 4, 2016, the description of which is incorporated herein by reference.

### BACKGROUND

Technical Field

The present invention relates to an apparatus for recognizing a shape of a road based on an image captured by a vehicle-mounted camera.

Related Art

There may be provided a turn-off lane branching off from a lane in which an own vehicle is traveling. Such a lane is hereinafter referred to as an own lane. A technique for determining whether or not the presence or absence of such a turn-off lane is disclosed in, for example, Japanese Patent Application Laid-Open Publication No. 2015-210618. A lane recognition apparatus disclosed in Japanese Patent Application Laid-Open Publication No. 2015-210618 is configured to determine the presence or absence of such a turn-off lane by comparing the left and right lane lines of the own lane. More specifically, when a degree of parallelism between the left and right lane lines of the own lane is equal to or less than a predetermined threshold, it is determined that there is a turn-off lane branching off from the own lane.

In the presence of a turn-off lane, a turn-off lane side lane line that is one of the left and right lane lines that demarcate an own lane may be curved in conformity with the shape of the turn-off lane despite the own lane being straight. In such a case, with a configuration that recognizes the shape of the own lane based on the left and right lane lines of the own lane, the lane recognition accuracy may be negatively impacted by the presence of the curved shape of the turn-off lane side lane line. That is, if edge points of the turn-off lane side lane line are included in edge points extracted from a captured image, the recognition accuracy of the shape of the own lane can decrease due to the presence of the turn-off lane.

In consideration of the foregoing, exemplary embodiments of the present invention are directed to providing an apparatus for accurately recognizing a shape of an own lane.

### SUMMARY

In accordance with an exemplary embodiment of the present invention, there is provided a road recognition apparatus mounted in a vehicle. In the apparatus, a lane line recognizer is configured to extract feature points from an image captured by a vehicle-mounted camera, and based on the extracted feature points, recognize lane lines that demarcate a lane of a road in which the vehicle is traveling. Such a lane is referred to as an own lane. A shape change point detector is configured to detect a shape change point along each of the lane lines, at which a shape of the lane line changes. A turn-off lane determiner is configured to, if the shape change point is detected, determine whether or not a shape changing lane line that is one of the lane lines including the shape change point constitutes a border of a turn-off lane branching off from the own lane. A road recognizer is configured to, when the shape change point has been detected, use only feature points of the left and right lane lines of the own lane located within a distance from the own vehicle to the shape change point to recognize the shape of the own lane, before a result of determination by the turn-off lane determiner is produced.

In such a configuration that the shape of the own lane is recognized based on the left and right lane lines of the own lane, if there is a turn-off lane branching off from the own lane, road shape recognition may be affected by a curved shape of a turn-off lane side lane line of the own lane. That is, if feature points of the turn-off lane are included in feature points extracted from a captured image, the recognition accuracy of the shape of the own lane may be affected to be reduced by the presence of the feature points of the turn-off lane.

With the above configuration, when a shape change point has been detected, only feature points of the left and right lane lines of the own lane located within the distance from the own vehicle to the shape change point are used to recognize the shape of the own lane, before a result of determination by the turn-off lane determiner is produced. In such a configuration, limiting the feature points used for road recognition until a result of determination by the turn-off lane determiner is produced allows for selection of the feature points of the own lane other than the feature points of the turn-off lane. That is, before a result of determination by the turn-off lane determiner is produced, recognition of the shape of the own lane is performed using only the feature points of the own lane, which can increase the recognition accuracy of the shape of the own lane.

### BRIEF DESCRIPTION OF THE DRAWINGS

FIG. 1A is a schematic diagram illustrating a mounting position of a vehicle-mounted camera in a vehicle;

FIG. 1B is a functional block diagram of an ECU;

FIG. 2 is an example of a travel trajectory around a branch point;

FIG. 3 is an example of detecting a shape change point;

FIG. 4 is a flowchart of processing to be performed in a road recognition apparatus;

FIG. 5 is an example of selecting edge points before a scene determination is made;

FIG. 6 is a plan view illustrating selection of edge points before the scene determination is made;

FIG. 7 is an example of selecting edge points after the scene determination is made; and

FIG. 8 is a plan view illustrating selection of edge points after the scene determination is made.

### DESCRIPTION OF SPECIFIC EMBODIMENTS

Embodiments of the present invention now will be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

System Configuration

A recognition system for recognizing lane lines in accordance with one embodiment of the present invention is mounted in a vehicle and includes a vehicle-mounted camera. The recognition system includes an electronic control unit (ECU) as a road recognition apparatus that is a main component of the recognition system to control lane line recognition.

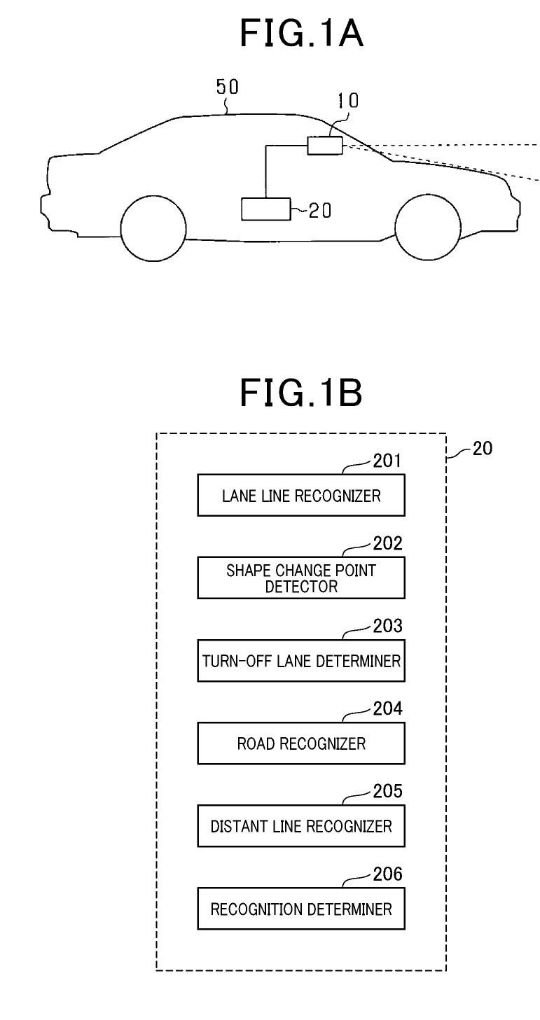

A schematic configuration of the road recognition apparatus of the present embodiment will now be described with reference to FIG. 1A. The own vehicle 50 includes the vehicle-mounted camera 10 and the ECU 20 connected to the camera 10. The vehicle-mounted camera 10 may include a monocular camera, such as a charge-coupled device (CCD) image sensor, a complementary metal-oxide semiconductor (CMOS) image sensor, or a near infra-red sensor, or a stereoscopic camera. As shown in FIG. 1A, the vehicle-mounted camera 10 may be placed near the top end of a front windshield of the own vehicle to capture an image of a front area that horizontally spans a pre-defined angle range about an imaging axis. Images captured by the vehicle-mounted camera 10 are to be output to the ECU 20 every predetermined time interval.

The ECU 20 may be microcomputer-based to include a central processing unit (CPU), a read-only memory (ROM), a random-access memory (RAM), an input/output (I/O) interface and other components (not shown). The ECU 20 extracts edge points and recognizes lane lines based on image information acquired from the vehicle-mounted camera 10. The lane lines may include solid lines and dashed lines, which may be white, yellow, blue, or other colors.

One of known driving assistance techniques is automatic driving. For automatic driving, a wide variety of scenes are supposed to be encountered when the own vehicle is traveling, one of which is a branch scene where there is a turn-off lane branching off from an own lane. Several techniques for determining such a branch scene have been proposed.

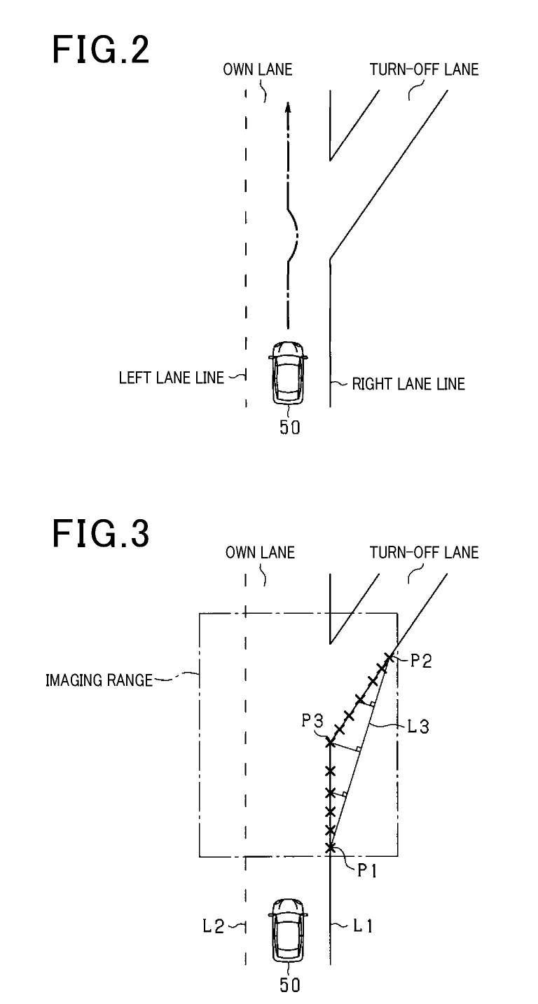

FIG. 2 illustrates an example of the branch scene. As shown in FIG. 2, in the case of the own lane being straight, a turn-off lane branches off and extends from the own lane, and a turn-off lane side line of the left and right lane lines that demarcate the own lane may be curved in conformity with the shape of the turn-off lane. Generally, recognition of the left and right lane lines is performed using all edge points extracted from a captured image. Hence, edge points of the turn-off lane will be taken into account in the road shape recognition. In such a configuration that the lane shape is recognized based on the left and right lane lines, road shape recognition may be affected by a curved shape of a turn-off lane side lane line. For example, if the road shape recognition is affected by the right lane line of the turn-off lane while the own vehicle 50 is traveling in a straight lane line, the trajectory of the own vehicle 50 may be curved rightward. Thus, in a configuration where the left and right lane lines are recognized using all edge points extracted from a captured image, the recognition accuracy of the shape of the own lane may be reduced.

In the present embodiment, the ECU 20 is configured to detect a shape change point at which the shape of a lane line changes, and if such a shape change point is detected, recognize a shape of the own lane using only edge points of the left and right lane lines of the own lane that are closer to the own vehicle 50 than the shape change point before a determination of the branch scene is produced. That is, unless a determination of the branch scene is produced, edge points used for road recognition are limited to edge points that are closer to the own vehicle 50 than the shape change point.

In the above, the shape change point is an edge point of a lane line at which it is recognized that the shape of the lane line changes. The shape change point may correspond to an edge point located at a junction between a lane line of the own lane and a lane line of a turn-off lane in a situation where the turn-off lane branches off and extends from the own lane, an edge point at the entry of a curve, or the like. That is, if such a shape change point is detected, it is likely that there is a turn-off lane or a curve in front of the own vehicle.

FIG. 3 illustrates an example of detecting a shape change point. In FIG. 3, the right one of the left and right lane lines of the own lane is a roadside solid lane line L1, and the left one is a dashed lane line L2 that is a border between the own lane and its adjacent lane. The right lane line L1 is a shape changing lane line including a shape change point. Two edge points P1, P2 having different distances to the own vehicle 50, along the right lane line L1, are connected by a straight line. In FIG. 3, the edge point P1 that is an edge point closest to the own vehicle 50, and the edge point P2 that is the most distant edge point from the own vehicle 50 are connected by a straight line L3. Further, in FIG. 3, perpendiculars from respective edge points along the lane L1 to the straight line L3 are drawn. The edge point P3, the perpendicular from which to the line L3 is the longest one, is detected as a shape change point. Any two edge points having different distances to the own vehicle 50 may be selected as the two edge points P1, P2.

If such a shape change point is detected, a shape changing lane line (lane line L1 in FIG. 3), along which the shape change point is detected, includes not only one of lane lines of the own lane, but also one of lane lines of the turn-off lane. That is, as shown in FIG. 3, part of the lane line L1 that is closer to the own vehicle 50 than the shape change point constitutes one of lane lines of the own lane whilst part of the lane line L1 that is more distant from the own vehicle 50 than the shape change point constitutes one of lane lines of the turn-off lane. In the present embodiment, the ECU 20 is configured to, if a shape change point is detected, determine whether or not a shape changing lane line including the shape change point is a lane line of the turn-off lane branching off from the own lane. More specifically, the ECU 20 is configured to make a scene determination as to whether the shape changing lane line is a border of the turn-off lane or a border of a curve. The ECU 20 is configured to, depending on the determined scene, select edge points of lane lines of the own lane, thereby recognizing the shape of the own lane.

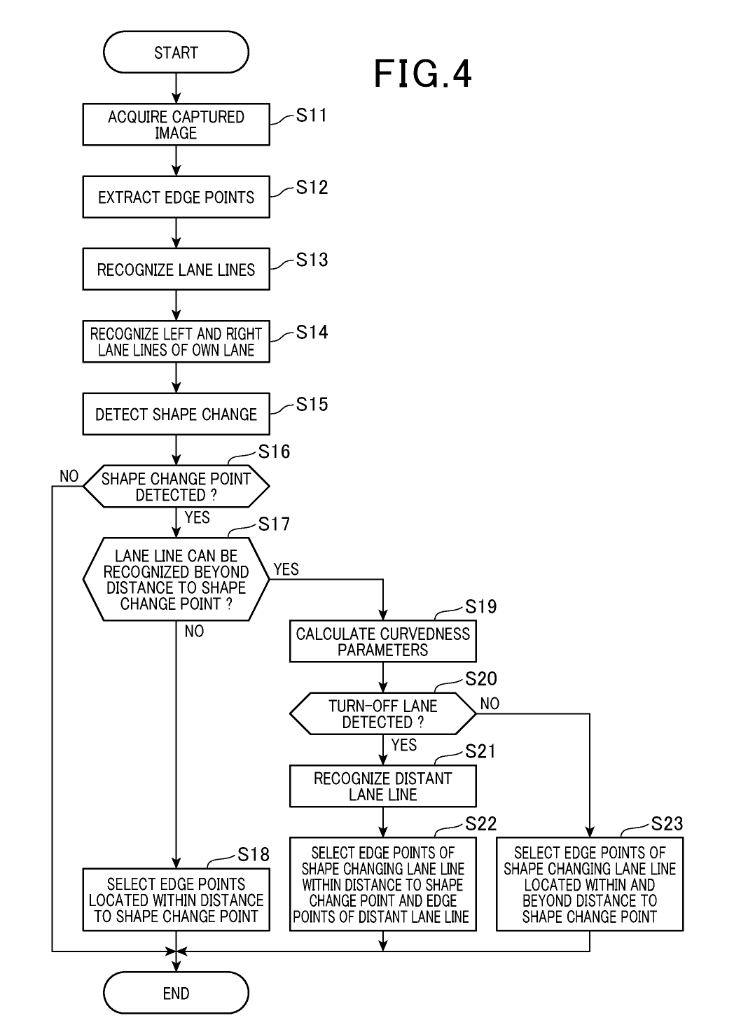

Processing to be performed in the road recognition apparatus will now be described with reference to a flowchart of FIG. 4. This processing is performed in the ECU 20 iteratively every predetermined time interval (e.g., 100 ms).

In step S11, the ECU 20 acquires an image captured by the vehicle-mounted camera 10. In step S12, the ECU 20 extracts edge points from the captured image. More specifically, the ECU 20 applies the Sobel filter or the like to the captured image to extract edge points that constitute outlines of a lane line. In step S13, the ECU 20 recognizes lane lines from the extracted edge points. For example, the ECU 20 may use a well-known approximation method or the like to recognize lane lines from edge points having a predetermined continuity degree. In step S14, the ECU 20 recognizes the left and right lane line of the own lane from the recognized lane lines. The left lane line of the own lane is a lane line that is recognized on the left hand side of the own vehicle 50 as being closest to the own vehicle 50. The right lane line of the own lane is a lane line that is recognized on the right hand side of the own vehicle 50 as being closest to the own vehicle 50.

In step S15, the ECU 20 detects, for each of the left and right lane lines of the own lane, a shape change point that is an edge point at which the shape of the lane line changes using, for example, a method as described above with reference to FIG. 3. That is, for each of the left and right lane lines L1, L2 of the own lane, perpendiculars are drawn from respective edge points to a straight line connecting two points having different distances to the own vehicle 50, along the lane line. The edge point P3, the perpendicular from which to the line L3 is the longest one, is detected as a shape change point. In step S16, the ECU 20 determines whether or not a shape change point has been detected. If it is determined that there is no shape change point detected (step S16; No), then the process flow ends. If it is determined that a shape change point is detected (step S16; Yes), then the process flow proceeds to step S17.

In the scene determination where the presence or absence of a turn-off lane is determined, it is required that edge points of the left and right lane lines have been detected. That is, to make an accurate scene determination, the left and right lane lines have to be well recognized beyond a distance from the own vehicle to the shape change point. The recognition may depend on types and conditions of lane lines. For example, a dashed, lane line cannot be recognized within a longer distance from the own vehicle as compared to the case of a solid, lane line. Dirtiness and blurring of lane lines may affect the lane line recognition.

In step S17, in light of the foregoing, the ECU 20 determines whether or not the lane line other than the shape changing lane of the own lane, that is, the lane line of the own lane on the opposite side of the own vehicle 50 from the shape changing lane line of the own lane, can be recognized beyond a distance from the own vehicle 50 to the shape change point. More specifically, the ECU 20 determines whether or not a recognition distance of the lane line other than the shape changing lane line, of the own lane, is greater than a distance from the own vehicle 50 to the shape change point and the shape of the lane line other than the shape changing lane line is also recognized beyond a distance from the own vehicle 50 to the shape change point. If “NO” in step S17, the process flow proceeds to step S18, where the shape of the own lane is recognized using only edge points of the left and right lane lines of the own lane that are closer to the own vehicle 50 than the shape change point. That is, edge points used for road recognition are limited to edge points that are closer to the own vehicle 50 than the shape change point.

If “YES” in step S17, the process flow proceeds to step S19. In step S19, the ECU 20 calculates curvedness parameters that are parameters indicative of a degree of curvature of each of the shape changing lane and the lane line other than the shape changing lane of the own lane in an area further from the own vehicle 50 than the shape change point. In step S19, the ECU 20 may calculate a slope and a curvature of each of the shape changing lane and the lane line other than the shape changing lane of the own lane. In step S20, based on the calculated curvedness parameters, the ECU 20 determines whether or not the shape changing lane line is a lane line, i.e., a border, of the turn-off lane at distances greater than the distance from the own vehicle 50 to the shape change point. In step S20, the determination is made based on instantaneous values of time-sequence data of the slope and curvature of each of the shape changing lane and the lane line other than the shape changing lane of the own lane. The ECU 20 may calculate a yaw angle and a clothoid parameter (a ratio of change of the curvature) in step S19, and based on the calculation result, make the scene determination in step S20. Alternatively, a well-known branch determination method may be used.

If in step S20 it is determined that the shape changing lane line is a lane line of the turn-off lane at distances greater than the distance from the own vehicle 50 to the shape change point (step S20; YES), then the process flow proceeds to step S21. In step S21, the ECU 20 recognizes a lane line of the own lane located beyond the distance from the own vehicle 50 to the shape change point. Such a lane line is hereinafter referred to as a distant lane line. In step S21, the ECU 20 may detect edge points continuing to part of the shape changing lane line within the distance from the own vehicle 50 to the shape change point, and based on the detected edge points, recognize the distant lane line of the own lane located beyond the distance from the own vehicle 50 to the shape change point. In some branch scenes, as shown in FIG. 2, no lane line may be provided at the branch point. Hence, with such a configuration that the distant lane line of the own lane is recognized, the recognition accuracy of the own lane can be improved. In step S22, the ECU 20 recognizes the shape of the own lane using the edge points of the shape changing lane line located within the distance from the own vehicle 50 to the shape change point and the edge points of the distant lane line of the own lane. In such a case, edge points of the turn-off lane are not taken into account in the recognition of the shape of the own lane. That is, the edge points of the turn-off lane are ignored in the recognition of the shape of the own lane.

In some embodiments, in step S21, the ECU 20 may determine whether or not a distant lane line can be recognized, and if a distant lane line cannot be recognized, recognize the shape of the own lane using only edge points of the left and right lane lines of the own lane that are closer to the own vehicle 50 than the shape change point. Additionally, if it is determined that a distant lane line cannot be recognized and if the own vehicle 50 has passed by the shape change point, the ECU 20 may delete all edge points of the turn-off lane. Even with such a configuration, the edge points of the turn-off lane are not taken into account in the road shape recognition.

If in step S20 it is determined that the shape changing lane line is not a lane line of the turn-off lane (step S20; NO), it is determined that the shape changing lane line is a border of a curve. Thereafter, the process flow proceeds to step S23. In step S23, the ECU 20 recognizes the shape of the own lane using the edge points of the shape changing lane line of the own lane located within the distance from the own vehicle 50 to the shape change point and the edge points of the shape changing lane line of the own lane located beyond the distance from the own vehicle 50 to the shape change point. That is, it is determined that the shape changing lane line is a lane line of the own vehicle, and the shape of the own lane is recognized using all the edge points of the shape changing lane line.

As shown in FIG. 1B, the ECU 20 includes, as functional blocks, a lane line recognizer 201 that executes steps S11-S14, a shape change point detector 202 that executes step S15, a turn-off lane determiner 203 that executes steps S19-S20, a road recognizer 204 that executes steps S18, S22, S23, a distant line recognizer 205 that executes step S21, and a recognition determiner 206 that executes steps S16-S17. Functions of these blocks may be implemented by the CPU executing computer programs stored in the ROM or the like.

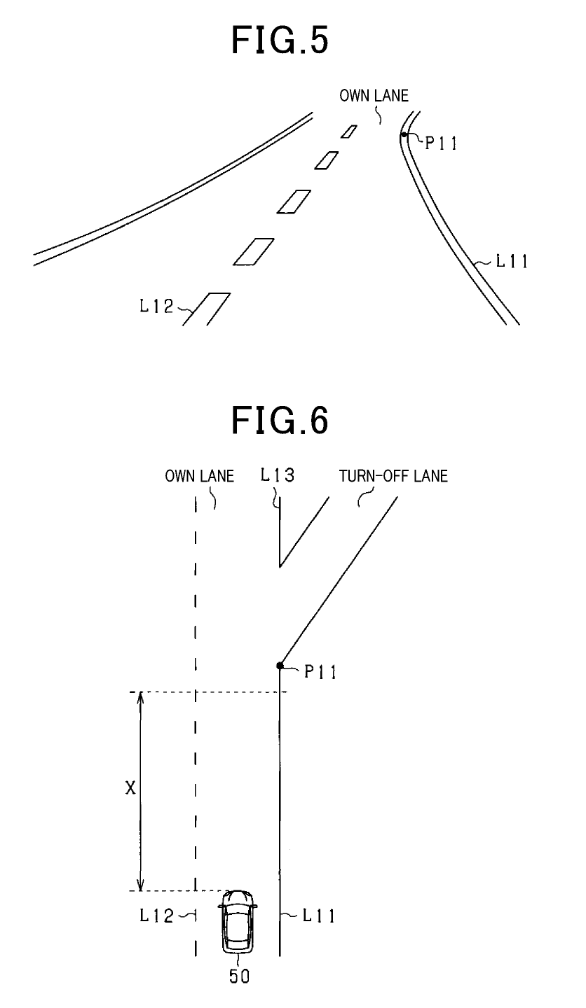

Selection of edge points before and after the scene determination is made will now be described with reference to FIGS. 5-8, where it is assumed that there are the left and right lane lines L11, L12 that demarcate the own lane around the current location of the own vehicle 50. It is further assumed that there is a turn-off lane on the right-hand side of the own vehicle in a territory using right-hand traffic. In such a situation, there is a shape change point P11 along the right lane line L11 of the own vehicle.

FIGS. 5 and 6 illustrate a situation before the scene determination is made. In such a situation, the left lane line L12 is not recognized beyond a distance from the own vehicle 50 to the shape change point P11. That is, for example, supposing that the right lane line L11 is a solid line and the left lane line L12 is a dashed line, a recognition distance X of the lane line L12 is considered to be less than that of the right lane line L11. Therefore, a distance from the own vehicle 50 to the shape change point P11 is greater than the recognition distance X of the lane line L12. Under such a circumstance, the ECU 20 limits the edge points used for road recognition to edge points of the lane lines of the own lane located within the distance from the own vehicle 50 to the shape change point. That is, edge points of the right lane line L11 located within the distance from the own vehicle 50 to the shape change point and the edge points of the left lane line L12 located within the recognition distance X are used for road recognition. The edge points of the lane lines of the own lane line are not used for road recognition located beyond the distance from the own vehicle 50 to the shape change point.

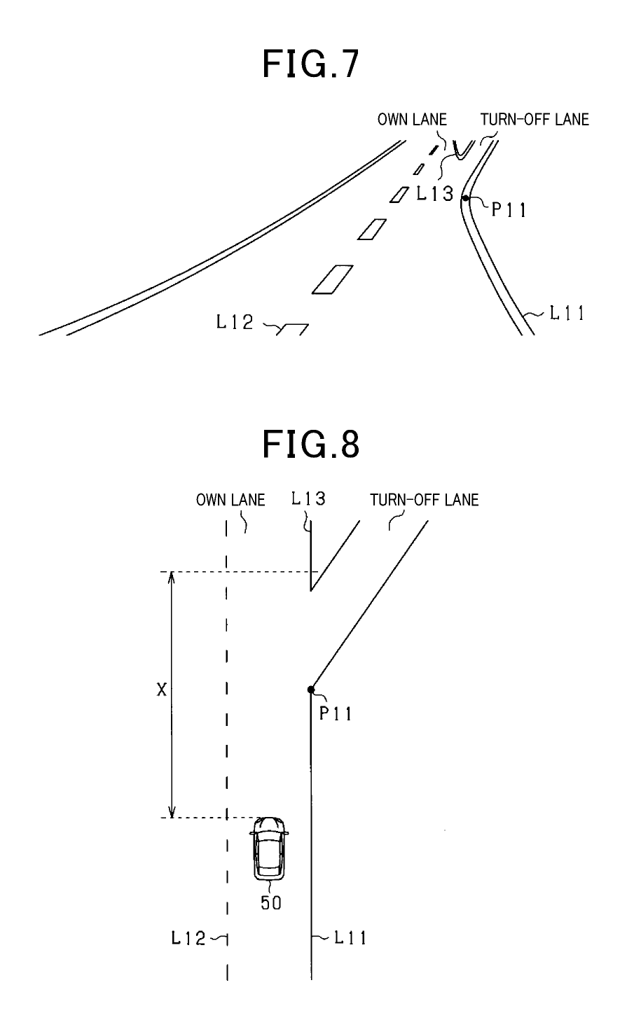

FIGS. 7 and 8 illustrate a situation after the scene determination is made. In such a situation, the left lane line L12 is recognized beyond a distance from the own vehicle 50 to the shape change point P11. Since the recognition distance X is greater than the distance from the own vehicle 50 to the shape change point P11, the ECU 20 can make a scene determination. It will then be determined that the shape changing lane line is a border or a lane line of a turn-off lane. Therefore, the edge points other than the edge points of the lane lines of the turn-off lane are selected. Thus, for the lane line L11, the edge points located within the distance from the shape change point P11 to the own vehicle 50 and the edge points of the lane line L13 (referred to as a distant lane line) are used for road recognition. For the lane line L12, the edge points within the recognition distance X are used for road recognition.

The road recognition apparatus of the present embodiment configured as above can provide the following advantages.

If feature points of a turn-off lane are included in feature points extracted from a captured image, the recognition accuracy of the shape of the own lane may be affected to be reduced by the presence of the feature points of the turn-off lane. In consideration of this deficiency, with the above configuration, in cases where a shape change point has been detected, only feature points (i.e., edge points) of the left and right lane lines of the own lane located within the distance from the own vehicle to the shape change point are used to recognize the shape of the own lane, before a result of determination by the turn-off lane determiner is produced. In such a configuration, limiting the feature points used to recognize the shape of the own lane until a result of determination by the turn-off lane determiner is produced allows for selection of the feature points of the own lane other than the feature points of the turn-off lane. That is, before a result of determination by the turn-off lane determiner is produced, recognition of the shape of the own lane is performed using only the feature points of the own lane, which can increase the recognition accuracy of the shape of the own lane.

In addition, if the shape changing lane line is a border, i.e., a lane line, of the turn-off lane, only the feature points of the shape changing lane line located within the distance from the own vehicle to the shape change point are used to recognize the shape of the own lane. With this configuration, the feature points of the turn-off lane are not taken into account (or are ignored) in recognition of the shape of the own lane, which can increase the recognition accuracy of the shape of the own lane. Further, in such a case, the shape of the own lane is recognized using the feature points of the distant lane line located beyond a distance from the own vehicle to the shape change point as well, which can increase the recognition accuracy of the own lane.

If the shape changing lane line is a border, i.e., a lane line, of a curve, not only the feature points located within a distance from the own vehicle to the shape change point, but also the feature points located beyond a distance from the own vehicle to the shape change point are used to recognize the shape of the own lane. If the shape changing lane line is a lane line of a curve, the shape changing lane line constitutes only the lane line of the own lane. There is no need for limiting the edge points to within the distance from the own vehicle to the shape change point. Therefore, in the case of the curve, the recognition accuracy of the own lane will not be reduced.

In turn-off lane determination, unless the left and right lane lines are well recognized within a distance where the turn-off lane determination is made, the turn-off lane may not be correctly determined. In consideration of this deficiency, in cases where the lane line other than the shape changing lane line of the own lane is recognized beyond a distance from the own vehicle to the shape change point, it is determined whether or not the shape changing lane line constitutes a border of the turn-off lane. With this configuration, recognizing the left and right lane lines of the own lane in an area further from the own vehicle than the shape change point allows determination of whether not the shape changing lane line constitutes a border of a turn-off lane to be properly made.

In scene determination, curvedness parameters indicative of a degree of curvature of each of the shape changing lane and the lane line other than the shape changing lane of the own lane in an area beyond a distance from the own vehicle to the shape change point are used. This configuration allows the scene determination to be made accurately.

The shape change point is detected using a method as described with reference to FIG. 3. This configuration allows the shape change point to be detected accurately.

Modifications

It is to be understood that the invention is not to be limited to the specific embodiment disclosed above and that modifications and other embodiments are intended to be included within the scope of the appended claims.

(M1) In the above embodiment, if the lane line other than the shape changing lane line, of the own lane, is recognized beyond a distance from the own vehicle to the shape change point, a scene determination is made. Alternatively, a threshold may be provided for the recognition level. For example, if the lane line other than the shape changing lane line, of the own lane, is recognized in an area further from the own vehicle than the shape change point by more than a predetermined distance, a scene determination is made. This allows the scene determination to be made more accurately.

(M2) In the above embodiment, the shape change point is detected using a method as described with reference to FIG. 3. Alternatively, shape change patterns for lane lines in various scenes where a turn-off lane or a curve occurs may be prepared. The shape change point in an actual vehicle's travel scene may be determined using shape change points defined in the shape change patterns. More specifically, based on a captured image, it is determined whether or not a shape change has occurred along an actual lane line, and then the shape change point is detected by matching the shape change to the shape change patterns.

In addition, in a branch scene or in a curve, a curvature changes at entry of the turn-off lane or the curve. A shape change point may be detected based on such a curvature change. More specifically, if an amount of curvature change exceeds a predetermined threshold, a point at which the curvature changes may be detected as a shape change point.

In some other alternative embodiments, a shape change point may be detected based on map information including road shape information.

What is claimed is:

1. A road recognition apparatus mounted in a vehicle, comprising:
a lane line recognizer configured to extract feature points from an image captured by a vehicle-mounted camera, and based on the extracted feature points, recognize lane lines that demarcate a lane of a road in which the vehicle is traveling, which lane being referred to as an own lane;
a shape change point detector configured to detect a shape change point along each of lane lines of the own lane, at which a shape of the lane line changes;
a turn-off lane determiner configured to, if the shape change point is detected, determine whether or not a shape changing lane line that is one of the lane lines of the own lane including the shape change point constitutes a border of a turn-off lane branching off from the own lane; and
a road recognizer configured to, when the shape change point has been detected, use only feature points of the left and right lane lines of the own lane located within a distance from the own vehicle to the shape change point to recognize a shape of the own lane, before a result of determination by the turn-off lane determiner is produced.

2. The apparatus according to claim 1, wherein
the turn-off lane determiner is configured to determine whether the shape changing lane line constitutes a border of the turn-off lane or a border of a curve of the own lane,
the road recognizer is configured to, if it is determined that the shape changing lane line constitutes a border of the turn-off lane, use only feature points of the shape changing lane line within a distance from the own vehicle to the shape change point to recognize the shape of the own lane, and if it is determined that the shape changing lane line constitutes a border of a curve of the own lane, use not only feature points of the shape changing lane line located within a distance from the own vehicle to the shape change point, but also feature points of the shape changing lane line located beyond a distance from the own vehicle to the shape change point, to recognize the shape of the own lane.

3. The apparatus according to claim 1, further comprising a distant line recognizer configured to, if it is determined that the shape changing lane line constitutes a border of the turn-off lane, recognize a distant lane line that is a border of the own lane located beyond a distance from the own vehicle to the shape change point,
wherein the road recognizer is configured to use not only feature points of the shape changing lane line located within a distance from the own vehicle to the shape change point, but also feature points of the shape changing lane line located beyond the distance from the own vehicle to the shape change point, to recognize the shape of the own lane.

4. The apparatus according to claim 1, further comprising a recognition determiner configured to determine whether or not the lane line other than the shape changing lane line of the own lane is recognized beyond a distance from the own vehicle to the shape change point,
wherein the turn-off lane determiner is configured to, if the lane line other than the shape changing lane line of the own lane is recognized beyond a distance from the own vehicle to the shape change point, determine whether or not the shape changing lane line constitutes a border of the turn-off lane.

5. The apparatus according to claim 1, the turn-off lane determiner is configured to, based on parameters indicative of a degree of curvature of each of the shape changing lane and the lane line other than the shape changing lane of the own lane in an area further from the own vehicle than the shape change point, determine whether or not the shape changing lane line constitutes a border of the turn-off lane.

6. The apparatus according to claim 1, the shape change point detector is configured to, for each of the lane lines of the own lane, draw perpendiculars from respective feature points to a straight line connecting two points along the lane line having different distances to the own vehicle, to detect a feature point associated with the longest perpendicular to the straight line as the shape change point.

7. The apparatus according to claim 1, wherein the shape change point detector is configured to detect the shape change point based on map information.
